(19) United States
(12) Patent Application Publication
(10) Pub. No.: US 2008/0054784 A1
(43) Pub. Date: Mar. 6, 2008

(54) Oled Pixel Layout

(75) Inventor: Walid Benzarti, Grenoble (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT AL'ENERGIE ATOMIQUE, PARIS FRANCE (FR)

(21) Appl. No.: 11/628,768

(22) PCT Filed: Jun. 17, 2005
(86) PCT No.: PCT/FR05/50456

§ 371 Date: Dec. 7, 2006

(30) Foreign Application Priority Data
Jun. 18, 2004 (FR) 0451293

(51) Int. Cl. H01J 1/62

(52) U.S. Cl. 313/483

(57) ABSTRACT

A microelectronic device with which light radiation may be produced, notably used for forming enhanced pixels of screens or displays of the OLED type for example.

### TECHNICAL FIELD AND STATE OF THE PRIOR ART

The present invention relates to a microelectronic device with which light radiation may be emitted and which might be used for example for forming an enhanced pixel matrix of displays or screens of the OLED (<<Organic Light Emission Displays>>) type.

OLED type screens are flat screens using the luminescent property of organic OLED diodes. A current-addressing device integrated to the pixels is generally provided for adjusting the luminescence of an OLED diode associated with a screen or display pixel.

An example according to the prior art of such an addressing device associated with a light-emitting diode 10, of the OLED type is illustrated in FIG. 1. This exemplary addressing device first of all includes a first thin film transistor or TFT marked as 11, operating as a switch, and the opening or closing of which is controlled by a selection signal for example as a voltage marked as vlin, applied on the gate of the latter.

The addressing device further includes at least one second thin film transistor or TFT marked as 12, with which a current id may be produced at the input of the light-emitting diode 10, depending on an control voltage vdat, the current id causing emission of radiation by the diode 10.

The control voltage vdat depends on a light intensity or luminance value to which the radiation emitted by the diode 10 is desirably set. For a certain value of the selection signal vlin, the first transistor 11 may be set into a <<closed>> state. The control voltage vdat is then applied on the drain of the first thin film transistor 11, and transmitted onto the gate of the second thin film transistor 12 connected to the source of the first transistor 11, the second transistor 12 then emitting the current id to the input of the light-emitting diode 10. The second transistor 12 thus plays the role of a current modulator at the input of the diode 10.

In order to benefit from maximum current stability and minimum sensitivity to voltage fluctuations between its drain and its source, the second transistor 12 is generally biased in a saturation state, by a bias voltage marked as Vdd, for example of the order of +16V, applied onto the drain of the second transistor 12.

In a screen or display pixel addressing device of the type which has just been described, the first transistor 11 and the second transistor 12 may be TFT type transistors, formed for example with an active layer based on amorphous silicon or polycrystalline silicon.

According to an alternative, notably described in document EP 1193741 A2, the current-modulating transistor 12 of such an addressing device, may optionally be replaced with two common drain transistors biased by the voltage +Vdd, and the respective sources of which are connected to an electrode of the light-emitting diode 10. As described in this document, with this alternative, it is possible to improve the yield of the method for manufacturing OLED pixel matrices, the yield being defined in this case by the ratio between the number of circuits which may be used at the end of the manufacturing method and the total number of circuits initially submitted to the manufacturing method.

The addressing device also comprises a capacitor 13, a so-called <<storage>> capacitor, provided for retaining the control signal vdat, when this signal is transmitted onto the gate of the second thin film transistor 12.

The capacitor 13 is generally laid out so that one of its electrodes marked as 14 is connected to the gate of the current-modulating transistor 12 and to the source of the first switching transistor 11, whereas the other electrode 15 is connected to ground or to a fixed potential. This ground or this fixed potential is generally provided by a line or a bus, the role of which, as described for example by the aforementioned document and document EP 1298634, is exclusively dedicated to biasing said second electrode of the storage capacitor Cs. In a matrix of pixels, the layout of the lines or of the buses used for biasing the storage capacitors Cs of the different pixels, is generally such that these lines or these buses cross other lines for example for forwarding data signals or signals for biasing current-modulating means, and may be a source of noise also called <<cross-talk>>.

In order to compensate leak phenomena of transistors 11 and 12 in this type of device, the capacitance value of the capacitor 13 is generally high and induces significant bulkiness of the latter. This bulkiness may limit the aperture ratio of the pixels. Moreover, biasing the second electrode of the storage capacitor Cs by a specific line and the bulkiness generated by this capacitor, make the laying out delicate of the different components of the pixel with respect to each other.

Optimization of the layout of the components and reduction of the size of the addressing device with respect to that of electroluminescent means in this type of circuit are continually sought after.

Thus, the problem is posed of improving the performances of the pixels of screens or displays, for example of the OLED type, notably in terms of aperture ratio. The problem is also posed of improving the electric performances of the device for addressing such pixels.

### DESCRIPTION OF THE INVENTION

The present invention proposes a microelectronic device with which light radiation may be produced, provided with a matrix including a plurality of pixels, each pixel being formed of a stack of layers and comprising:

electroluminescent means, capable of emitting light radiation, depending on an inputted current,

current-modulating means capable of modulating said input current of the electroluminescent means according to a control signal forwarded by a line of data,

switching means connected to said line of data, capable of transmitting said control signal or not, to the current-modulating means according to a selection signal,

a selection line connected to switching means capable of forwarding said selection signal to the switching means,

a bias line connected to current-modulating means, capable of forwarding a signal for biasing the current-modulating means,

a storage capacitor, capable of retaining said control signal at the input of the current-modulating means and comprising a first electrode connected to the current-modulating means, the second electrode of the capacitor being connected to another line for selecting another pixel of the matrix or to said bias line.

The current-modulating means may be located between the switching means and the storage capacitor in said stack of layers.

Such a layout may provide a restriction on the number of crossings of different lines or semiconducting and/or metal areas within each pixel.

According to a possibility for laying out the device, the current-modulating means as well as at least one portion of the storage capacitor may be located between the bias line and the electroluminescent means.

In a matrix of pixels according to the invention, said second electrode of the capacitor is not connected to a line or to a bus, the role of which is specifically and exclusively dedicated to biasing the latter, but to a line with another function, for example that of forwarding the signal for selecting another pixel, or for example that of biasing the current-modulating means of said pixel.

With this, it is notably possible to facilitate the laying out of the components of said pixel, as well as a gain in space within each pixel of the matrix. With this gain in space, it is possible to obtain pixels with reduced size and/or to improve the aperture ratio of each of said pixels. With this, it is also possible to reduce the number of crossings between lines capable of forwarding an electric signal within a same pixel, and thus reduce the interferences of the <<cross-talk>> type which may be generated by these crossings.

The modulating means are connected to a bias line. With this, it is possible to associate each pixel of the matrix with a standard addressing electronic circuit or to preserve oneself from a specific addressing circuit.

According to an embodiment of the microelectronic device according to the invention, wherein the modulating means include at least one gate capable of receiving said control signal and formed from a layer, a so-called gate material layer, the first electrode of the storage capacitor may be connected to said gate and formed from a layer, a so-called active layer, different from the gate material layer.

The second electrode of the capacitor and said other line for selecting the other pixel may be connected and formed from a same layer, for example the gate material layer.

With such layouts, the number of crossings between lines or semi-conducting and/or metal areas forwarding different signals within each pixel may be limited and noise as well as short circuit risks may be limited.

Said electroluminescent means may comprise an electrode formed with at least one layer of organic nature. Said matrix may then be an OLED pixel matrix.

Said switching means may comprise at least one thin film transistor. The current-modulating means as for them may comprise at least one thin film transistor.

According to one possibility, the current-modulating means may also comprise a thin film transistor.

According to one alternative, the current-modulating means may comprise a first thin film transistor and a second thin film transistor sharing a common drain region.

If the second electrode of the capacitor is connected to another line for selecting another pixel, said other pixel may be a pixel neighbouring said pixel, for example located on a same vertical row of the matrix of pixels as the latter. The storage capacitor may be in contact with said other line for selecting said neighbouring pixel over a distance of at least 50 μm or half the width of the pixel.

The storage capacitor may assume several shapes. According to an advantageous embodiment, the latter may comprise a portion located between the bias line and the electroluminescent means and another portion located between the electroluminescent means and said line for selecting said other pixel.

According to a particular embodiment of the device according to the invention, said storage capacitor may have the shape of an L, which may notably facilitate the layout of the components within each pixel. With this particular shape, when one of the bars forming the ‘L’ is in contact and parallel with the line for selecting another pixel, a storage capacitor with good electric properties may also be obtained.

In a pixel matrix according to the invention, the storage capacitor may optionally be formed with two capacitors placed in parallel.

The invention also relates to a microelectronic device with which light radiation may be produced, provided with a matrix including a plurality of pixels, each pixel being formed with a stack of layers and comprising:

electroluminescent means capable of emitting light radiation according an inputted current,

current-modulating means,

switching means connected to said line of data, capable of transmitting said control signal or not, to the current-modulating means depending on a selection signal,

a selection line connected to the switching means capable of forwarding said selection signal towards the switching means,

a bias line connected to the current-modulating means, capable of forwarding a signal for biasing the current-modulating means,

a capacitor, capable of retaining said control signal at the input of the current-modulating means and comprising a first electrode connected to the current-modulating means and a second electrode of the capacitor connected to said bias line, the modulating means being located in said stack, between the storage capacitor and the switching means.

According to one possibility, the modulating means may include at least one gate capable of receiving said control signal and formed from a layer, a so-called gate material layer, the first electrode of the storage capacitor being connected to said gate and formed from a layer, a so-called “active layer”, different from the gate material layer.

According to one layout possibility of the device, the current-modulating means as well as at least one portion of the storage capacitor may be located between the bias line and the light-emitting diode.

### BRIEF DESCRIPTION OF THE DRAWINGS

The present invention will be better understood upon reading the description of exemplary embodiments given purely indicatively and by no means in a limiting way, with reference to the appended drawings wherein:

FIG. 1 illustrates an electric diagram of an OLED pixel according to the prior art,

FIGS. 2 and 3 illustrate electric diagrams of exemplary pixel matrices according to the invention,

FIG. 4 illustrates an exemplary stack of layers comprised in a matrix of pixels according to the invention,

FIGS. 5A, 5B, 5C, 5D illustrate the patterns of different layers of such a stack,

FIG. 6 illustrates another stack of layers comprised in an alternative matrix of pixels according to the invention,

FIGS. 7A, 7B, 7C, illustrate the patterns of different layers of such another stack,

FIGS. 8A, 8B, illustrate another exemplary stack of layers comprised in another alternative OLED pixel matrix according to the invention.

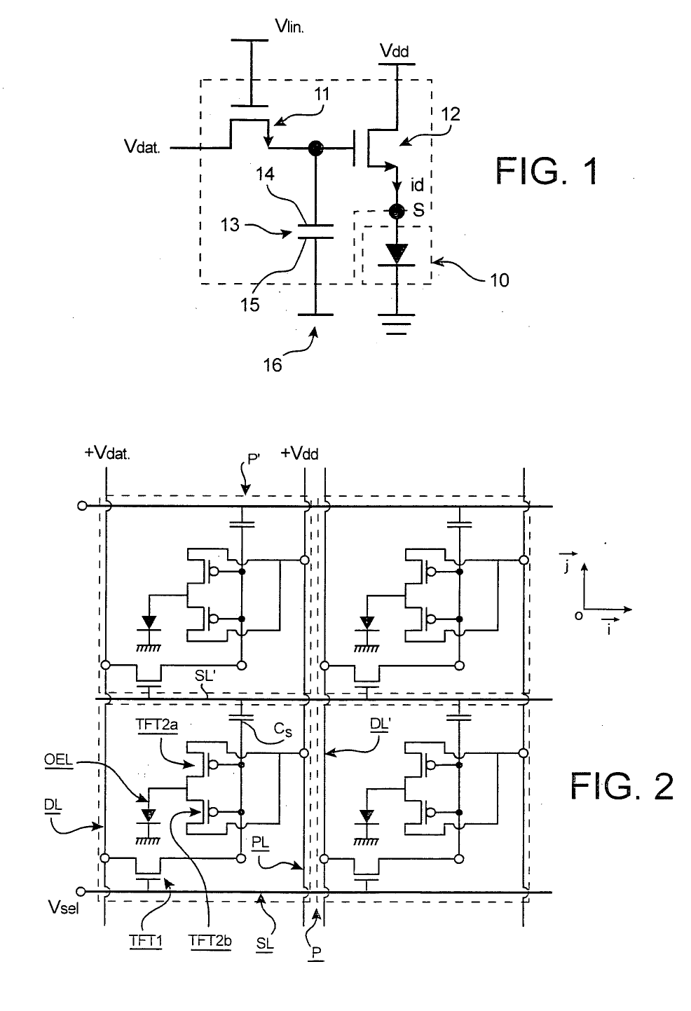

The different parts illustrated in the figures are not necessarily illustrated according to a uniform scale, so as to make the figures more legible.

### DETAILED DESCRIPTION OF PARTICULAR EMBODIMENTS

A microelectronic device implemented according to the invention will now be described in connection with FIG. 2. This device comprises a matrix of m (with m an integer) lines or <<horizontal rows>> (along the direction of the \vec{i} axis of an orthogonal reference system [O; \vec{i}; \vec{j}] defined in this figure) and p (with p an integer) columns or <<vertical rows>> (along the direction of a \vec{j} axis of the orthogonal reference system [O; \vec{i}; \vec{j}]) of pixels or OLED type cells.

In FIG. 2, a pixel P is notably distinguished, which first of all comprises electroluminescent means of an organic nature, for example an OLED type diode which will be marked as OEL. The OEL diode is capable of emitting light radiation depending on a current which is supplied to it at the input by current-modulating means, for example like a first thin film transistor TFT2a and a second thin film transistor marked as TFT2b. The respective source regions of the first thin film transistor TFT2a and of the second thin film transistor marked as TFT2b are each connected to the anode of the OEL diode. The current-modulating means are biased by a bias voltage +Vdd for example +16V, forwarded by a bias line marked as PL connected to a drain region common to the TFT2a and TFT2b transistors.

In this example, the bias line PL extends in the same direction as that of the vertical rows of the matrix of pixels. The bias line PL may be shared by several pixels belonging to the same vertical row as pixel P, or even to the whole of the pixels belonging to the same vertical row of the matrix as pixel P.

The current emitted from the current-modulating means TFT2a and TFT2b towards the OEL diode of pixel P, notably depends on an control voltage vdat forwarded by a line which will be marked as DL and which will be called <<data line>>. This data line DL extends in this example, in the direction of the vertical rows of the matrix. The data line DL may be shared by several pixels, or even by the whole of the pixels belonging to the same vertical row as pixel P.

The data line DL is connected to switching means, which assume the shape for example of a thin film transistor marked as TFT1. The source of the TFT1 transistor is connected to the gates of the TFT2a and TFT2b transistors. With the TFT1 transistor, the control voltage vdat, may either be transmitted or not onto the gate of the TFT2a transistor and onto the gate of the TFT2b transistor, depending on a so-called selection signal marked as vsel.

The selection signal vsel is applied for example onto the gate of transistor TFT1.

The selection voltage vsel of pixel P is forwarded by a so-called selection line, marked as SL, which extends in this example, in the same direction as that of the horizontal rows of the matrix. The selection line SL may be shared by several pixels, or even by the whole of the pixels belonging to the same horizontal row as pixel P. Thus, in this example, the pixels of the matrix are addressed, horizontal row by horizontal row.

The pixel P further comprises a so-called storage capacitor Cs, with which the control signal vdat may be retained, when this signal is transmitted to the current-modulating means TFT2a and TFT2b. The capacitor Cs is laid out so that one of its electrodes is connected to the respective gates of the modulating transistors TFT2a and TFT2b, whereas the second electrode is connected to a line or a bus playing the role of a ground or fixed potential line.

According to an enhanced layout within the pixel, the modulating transistors TFT2a and TFT2b may be located between the switching transistor and the storage capacitor Cs. Such a layout may provide reduction of so-called cross-talk noise within the pixel.

The line or the bus connected to the second electrode of the capacitor Cs, corresponds in this example to a selection line SL′ of another pixel P′ neighbouring pixel P and located on the same vertical row as the latter. The selection line SL′ belonging to the neighbouring pixel P′ provides forwarding of a signal for selecting said neighbouring pixel P′, In this exemplary matrix, as the pixels are addressed horizontal row by horizontal row, when the light intensity of the OEL diode associated with the pixel P is changed, the selection line SL forwards the selection signal vsel to the pixel P, whereas the other selection line SL′ of said neighbouring pixel P′ is inactive and does not forward any selection signal. P′ is preferably the pixel neighbouring the line addressed previously. Indeed, if P′ is addressed after P, the charge on the terminals of the capacitor Cs is likely to be changed during the addressing of the line which it uses as an electrode. The other selection line SL′ may then play the role of ground for the second electrode of the capacitor Cs. When SL′ is inactive, it is held at a fixed potential, for example between −2 V and +2 V, generally close to 0V.

In this example, for a given pixel, a line or a bus was not used, the role of which is exclusively and specifically dedicated to biasing the second electrode of the storage capacitor Cs. This bias in this example is provided by the line SL′ for selecting said neighbouring pixel P′, which also has the role of forwarding the signal for selecting said neighbouring pixel P′.

Such a pixel layout may be compatible with a standard addressing electronic circuit, for example a circuit of the type of those used for LCD (Liquid Crystal Display) matrices.

According to an alternative of the exemplary device described earlier, the transistors TFT2a and TFT2b with a common drain may optionally be replaced with a single thin film transistor, for which the drain is biased by the line PL, the source is connected to the anode of the electroluminescent means OEL, and the gate connected to the first electrode of the storage capacitor. This modulating transistor may be located between the switching transistor and the storage capacitor.

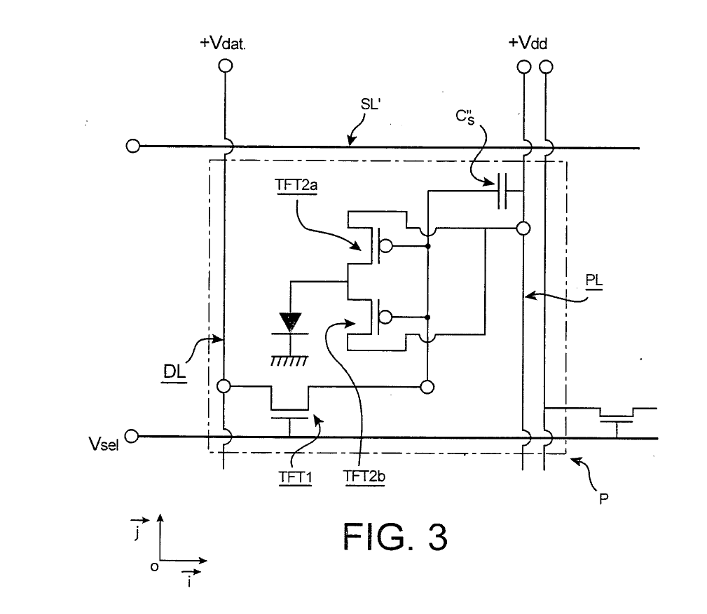

FIG. 3 illustrates an alternative of the exemplary device described earlier. The storage capacitor comprised in each pixel of the matrix, and notably in pixel P, is marked this time as C″s and first of all comprises a first electrode connected to the gates of the current-modulating transistors TFT2a and TFT2b, and a second electrode connected to the bias line PL of pixel P.

In this example, as in the example described earlier, for a given pixel, a line or a bus is not used, the role of which is exclusively and specifically dedicated to biasing the second electrode of the storage capacitor. This bias is provided by the line PL with which the signal biasing current-modulating transistors TFT2a and TFT2b may further be forwarded. The layout within the pixel may be such that the current-modulating transistors TFT2a and TFT2b are located between the switching transistor and the storage capacitor. Such a layout may provide reduction of so-called <<crosstalk>> noise within the pixel.

The bias line PL is held at a fixed potential for example of the order of +16V, the voltage levels used for the control voltages vdat and selection voltages vsel of the pixel P, will be different from those used in the example described earlier in connection with FIG. 2. Typically vdat is of the order of 10V and vsel of the order of 15V.

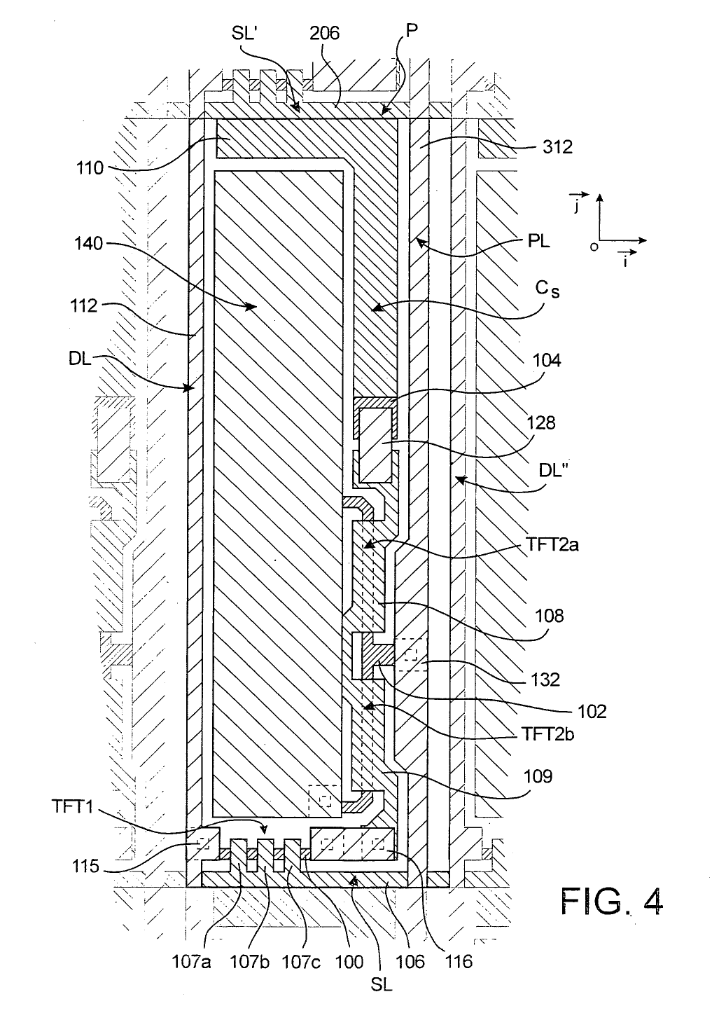

FIG. 4 illustrates a technological stack or a stack of layers as viewed from the top, of a portion of an OLED cell or pixel matrix of the type of that described earlier in connection with FIG. 2. In the illustration of this stack, the pixel P delimited on each side by buses or lines for forwarding electric signals is notably seen.

The pixel P is notably delimited by a line marked as 112 which belongs to it and by another line marked as 312 belonging to a neighbouring pixel P″ located on a same horizontal row of the matrix as the pixel P. Lines 112 and 312 extend in a direction parallel to the \vec{j} axis of an orthogonal reference system [O; \vec{i}; \vec{j}] defined in FIG. 4, which corresponds to the same direction as the one of the vertical rows of the matrix. Lines 112 and 312 respectively correspond to the data line DL capable of forwarding the control signal vdat of the pixel P and to a data line marked as DL″ capable of forwarding the control signal of the neighbouring pixel P″.

Pixel P is moreover delimited by another pair of lines, of which one is marked as 106 and belongs to it, and another one of which is marked as 206 and belongs to another neighbouring pixel P′ located on a same vertical row of the matrix as the pixel P.

Lines 106 and 206 extend in a direction parallel to the \vec{i} axis of the orthogonal reference system [O; \vec{i}; \vec{j}], corresponding to the same direction as the one of the vertical rows of the matrix. Lines 106 and 206 respectively correspond to the selection line SL capable of forwarding the selection signal vsel of the pixel P, and to another line of data SL′ capable of forwarding the signal vsel′ for selecting the neighbouring pixel.

In this example, the layout of pixel P is such that the switching transistor TFT1, is placed in proximity to a crossing between the line of data DL and the selection line SL, as well as in proximity to the current-modulating transistors TFT2a and TFT2b. The transistors TFT2a and TFT2b as for them, are placed between an area with a rectangular shape marked as 140, which corresponds to an electrode of the OEL light-emitting diode, and a line marked as 128, which extends in a direction parallel to the \vec{j} axis of the reference system [O; \vec{i}; \vec{j}], and which corresponds to the bias line PL of said current-modulating transistors TFT2a and TFT2b. Within the stack of thin layers, the modulating transistors TFT2a and TFT2b may also be located between the switching transistor TFT1 and the storage capacitor Cs. With this layout, it is possible to reduce the number of crossings between horizontal and vertical, semiconducting and/or metal areas or lines of the pixel. Cross-talk type noise or noise from crossings and the risks of short-circuits may thereby be reduced.

The storage capacitor of the pixel P as for it fits to the shape of the electrode 140 of the light-emitting diode. This storage capacitor Cs includes a first portion located between the electrode 140 of the light-emitting diode and the bias line PL, and a second portion located between the selection line SL′ of said neighbouring pixel P′ and the electrode 140 of the light-emitting diode.

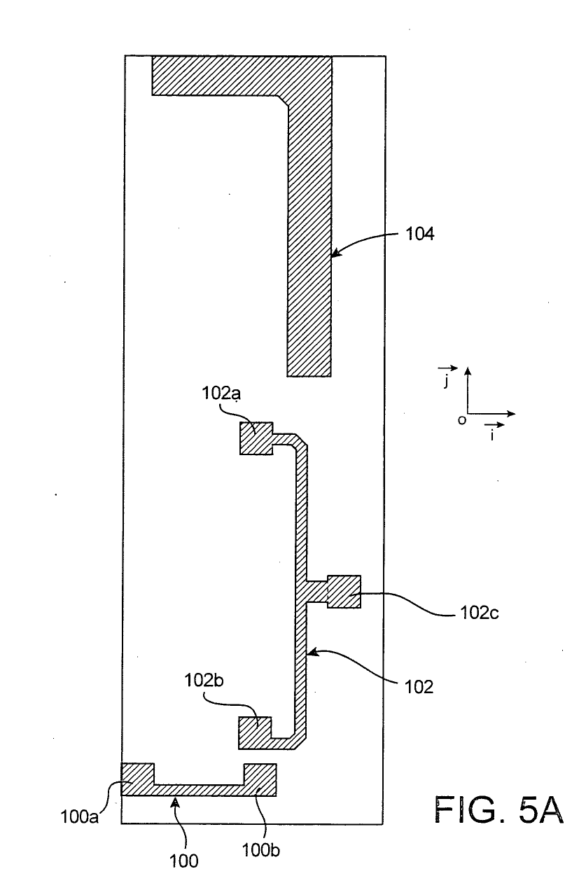

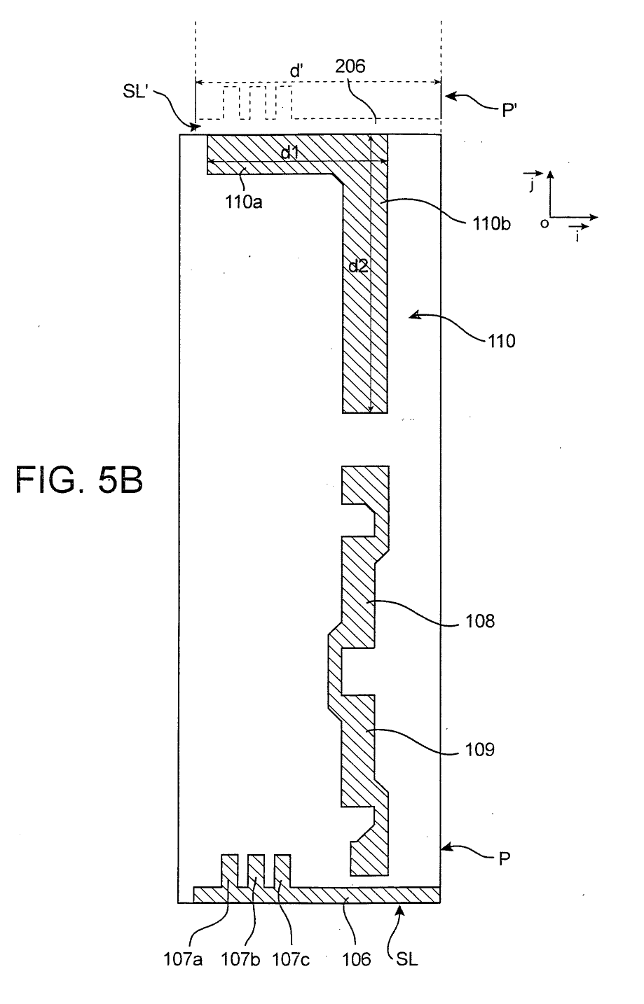

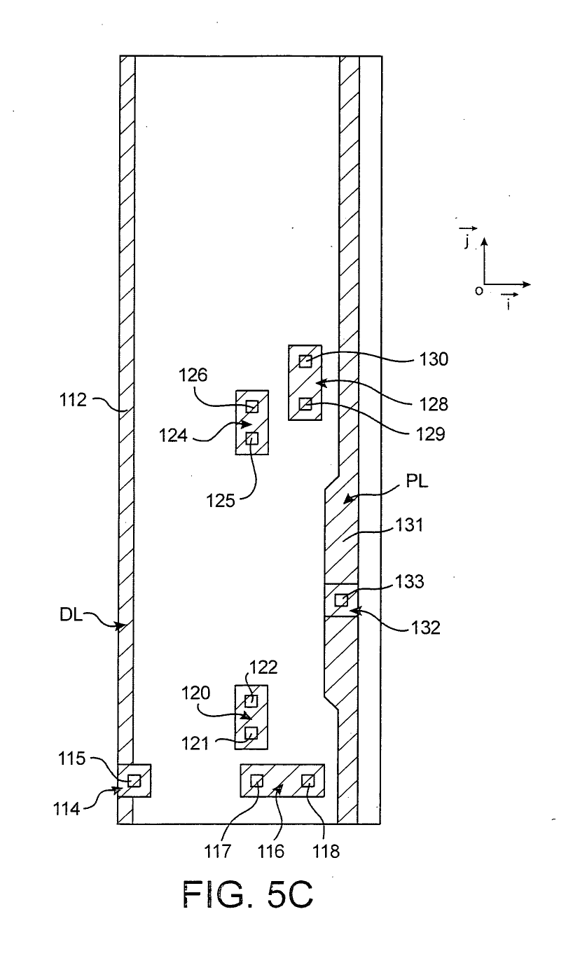

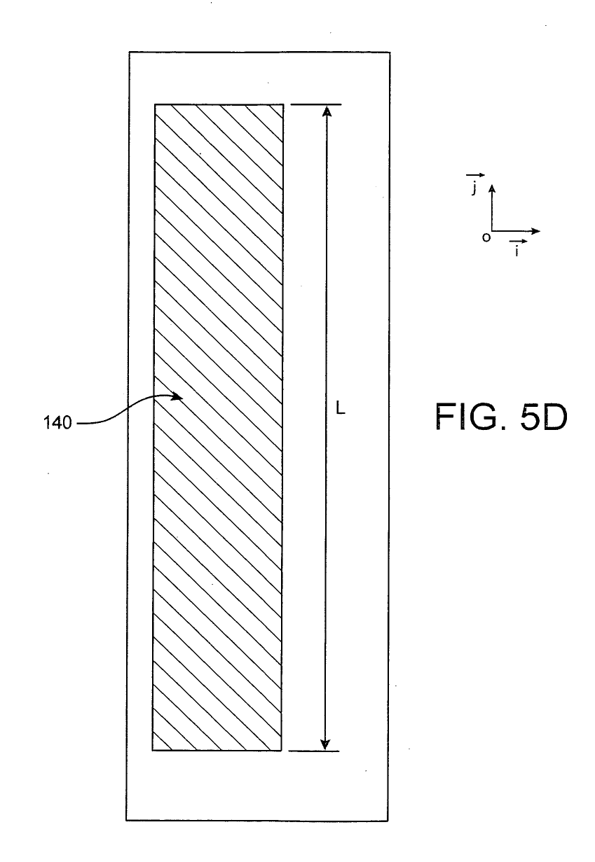

Said technological stack is notably formed with an active layer, for example based on polysilicon, the patterns of which are moreover illustrated in a top view in FIG. 5A. In an area marked as 100 of this active layer, a drain region 100a, as well as a source region 100b of the switching transistor TFT1, is notably formed.

In another area marked as 102, a source region 102a of the first current-modulating transistor TFT2a, another source region 102b of the second current-modulating transistor TFT2b as well as a drain region 102c common to the first and second current-modulating transistors are formed, respectively.

Another area of the active layer marked as 104, assuming the shape of an ‘L’, as for it, corresponds to a first electrode of the storage capacitor Cs. This first electrode is covered with an insulator (not shown) for example based on SiO₂, which may be formed in the same layer as the gate insulator of transistors TFT1, TFT2a and TFT2b, respectively.

The layout of the areas 100, 102, 104 may be such that the area 102 is located between the area 100 and the area 104. In other words, the active area of the current-modulating transistors TFT2a and TFT2b is located between the active area of the switching transistor TFT1 and the first electrode of the storage capacitor Cs.

A layer based on gate material, for example aluminium, surmounts said insulator of the gate and of the capacitor Cs. The patterns of this layer based on gate material are illustrated in FIG. 5B and notably comprise line 106, which corresponds to said line SL for selecting the pixel P.

Juxtaposed areas marked as 107a, 107b, 107c, are each connected to the line 106. As is shown by the stack of FIG. 4, these juxtaposed areas 107a, 107b, 107c cover a portion of the area 100 of the active layer (FIG. 5A) and form a multi-gate structure for the switching transistor TFT1.

The layer based on gate material also comprises portions 108 and 109, which, as is shown by the stack of FIG. 4, cover portions of the area 102 of the active layer which correspond to the gate of the first switching transistor TFT2a and to the gate of the second switching transistor TFT2b, respectively.

Another area of the gate material layer, assuming the shape of an ‘L’ and marked as 110 in FIG. 5B as for it, corresponds to the second electrode of the storage capacitor Cs. The portions 108 and 109 of the layer based on gate material corresponding to the gate of the first switching transistor TFT2a and to the gate of the second switching transistor TFT2b, respectively, are separated from the area 110 of the layer based on gate material.

The second electrode as for it, is connected to the line marked as 206 which corresponds to the selection line SL′ of said neighbouring pixel P′. The second electrode of the capacitor and the selection line SL′ of the pixel P′ may be thereby connected and formed from a same layer, in particular from the gate material layer.

The line 206 is used as a fixed potential line or a ground line for the second electrode of the capacitor. The pixel according to the invention does not comprise any line or area, the role of which is specifically dedicated to that of a ground line or a fixed potential line for the second electrode of the storage capacitor. In this example, it is line 206 which plays this role and which is also used as a selection line SL′ for the neighbouring pixel P′.

A portion marked as 110a of the area 110, extends in a direction parallel to the \vec{i} axis of the reference system [O; \vec{i}; \vec{j}] and forms the horizontal bar of the ‘L’. This portion 100a has a length d1 which may be of the order of 50 μm, for example 58 μm, and which is in contact with the selection line SL′ of the neighbouring pixel P′, over a distance equal to the distance d1.

The contact distance between the second electrode of the capacitor Cs and the selection line SL′ of the neighbouring pixel may vary according to the shape of the capacitor Cs.

The contact distance between the second electrode of the capacitor and the selection line SL′ may for example be between 10 μm and 90 μm for a pixel with for example dimensions 120 μm*360 μm or for example be of at least ⅕^{th} of the width of the pixel and of at most ⅘^{th} of the width of the pixel. The area 110 forming the second electrode of the capacitor Cs may have a surface, for example of the order of 3,300 μm² for a capacitance of the capacitor of the order of 1.2 pF. Another portion marked as 110b of this area 110 forms the horizontal bar of the ‘L’, and extends in a direction parallel to the \vec{j} axis of the reference system [O; \vec{i}; \vec{j}]. This portion 100b has a length d2 which may be of the order of 60 μm, for example 67 μm.

A pixel implemented according to the invention is not limited to an ‘L’ shape. This ‘L’-shape allows a significant contact distance to be kept between the second electrode of the capacitor and the selection line SL′ of the neighbouring pixel P′, and a storage capacitor Cs with good electric properties, while limiting the bulkiness of the latter.

A layer based on dielectric material (not shown) for example based on SiO₂, rests on the layer 111 based on gate material. A metal layer, the patterns of which are illustrated in FIG. 5C is found above said layer based on dielectric material. In this metal layer, for example based on molybdenum, the line 112 is formed, which corresponds to the data line DL of the pixel P. A node marked as 114 belonging to this data line DL is electrically connected, through a vertical contact or a via marked as 115, to the drain region of the TFT1 transistor.

A second node 116, also formed in the metal layer, may provide a connection between the source region of the switching transistor TFT1 and the gate 108 of the first current-modulating transistor TFT2a, through vertical contacts or vias marked as 117 and 118. In this same metal layer, a third connection node marked as 120 through vertical contacts or vias marked as 121 and 122, provides an electrical connection between the source region of the first current-modulating transistor TFT2 and the area marked as 140, used as an anode for the OEL light-emitting diode.

A fourth connection node marked as 124 as for it, via vertical contacts marked as 125 and 126, provides an electrical connection between the source region of the second current-modulating transistor TFT2b and the anode area 140 of the OEL diode.

A fifth connection node marked as 128, also formed in the metal layer, has the role of providing a connection between the first electrode of the capacitor Cs and the gate region of the current-modulating transistor TFT2a, via vertical contacts 129 and 130.

The first electrode of the storage capacitor is connected to said gate of the current-modulating transistor TFT2a, and is thereby capable of receiving the control signal. The first electrode of the storage capacitor and the gate of the current-modulating transistor TFT2a are formed from different layers.

The line marked as 131, which corresponds to the bias line PL of the current-modulating transistors TFT2a and TFT2b is also formed in the metal layer. Via a vertical contact 133, a connection node marked as 132, belonging to this bias line PL is electrically connected to the drain region common to the transistors TFT2a and TFT2b.

The technological stack may further comprise a passivation layer, over the metal layer illustrated in FIG. 5B, as well as another layer illustrated in FIG. 5D, surmounting the passivation layer and in which the area 140 forming the anode of the OEL light-emitting diode is made. This area 140 may be based on ITO (indium tin oxide) and for example have the shape of a rectangle with length L (defined in FIG. 5D in a direction parallel to the \vec{j} axis of the reference system [O; \vec{i}; \vec{j}]) for example of the order of 250 μm, for example 253 μm.

Above the ITO-based layer forming the anode of the OEL light-emitting diode, the stack illustrated in FIG. 4 and in FIGS. 5A-5D is completed by at least one layer of organic nature with injections of carriers (not shown), for example based on Alq3 capable of emitting light radiation. In a pixel implemented according to the invention, no specific power supply or bias line is used for the second electrode of the storage capacitor Cs. As this second electrode is connected to the selection line SL′ of another pixel, the pixel whose technological stack has just been described, has a number of buses less than that of the pixels according to the prior art, which may notably provide a gain in space in the layout of said pixel and improve its aperture ratio, or possibly achieve formation of a pixel with reduced size relatively to those of the prior art.

As the number of buses in the pixel according to the invention is reduced, the number of crossings between buses or lines with which electric signals are forwarded within a same pixel is also reduced, so that certain noise or cross-talk phenomena due to these crossings may notably be reduced.

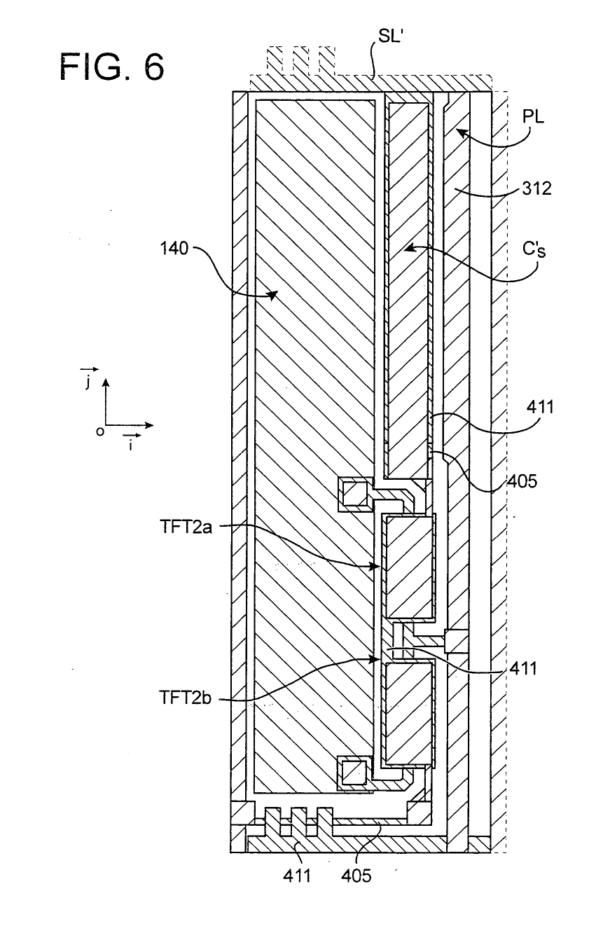

FIG. 6 illustrates another exemplary technological stack of the type of the one described earlier, but which is notably different at the level of the structure and shape of the storage capacitor comprised in each pixel.

In this example, the storage capacitor C′s comprised in the pixel, differs from the one illustrated in connection with FIG. 4, in that it is formed with two capacitors C′s1 and C′s2 placed in parallel with each other. Moreover the capacitor C′s has the shape of a rectangle (the length of which is parallel to the \vec{j} axis of a reference system [O; \vec{i}; \vec{j}] defined in this FIG. 6) and which is found placed between the bias line PL and the electrode 140 of the light-emitting diode.

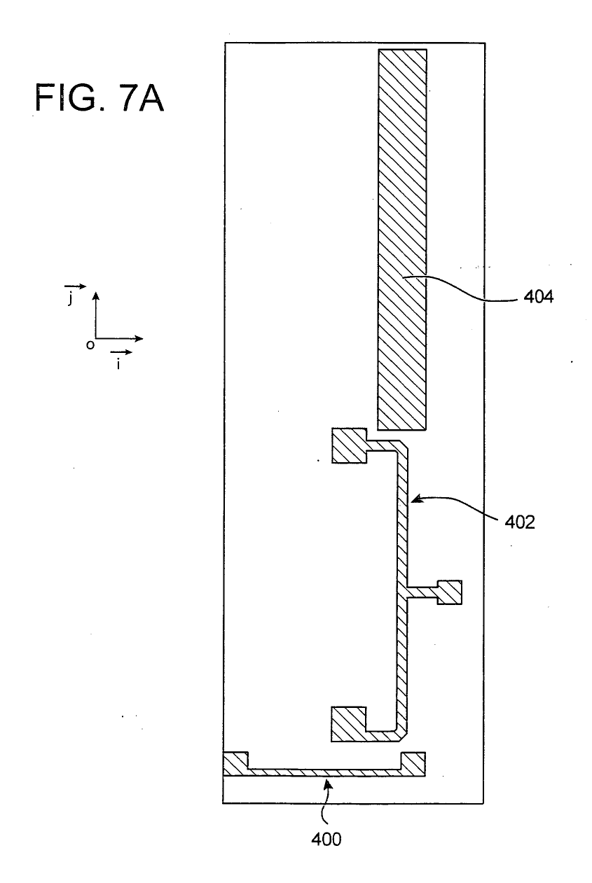

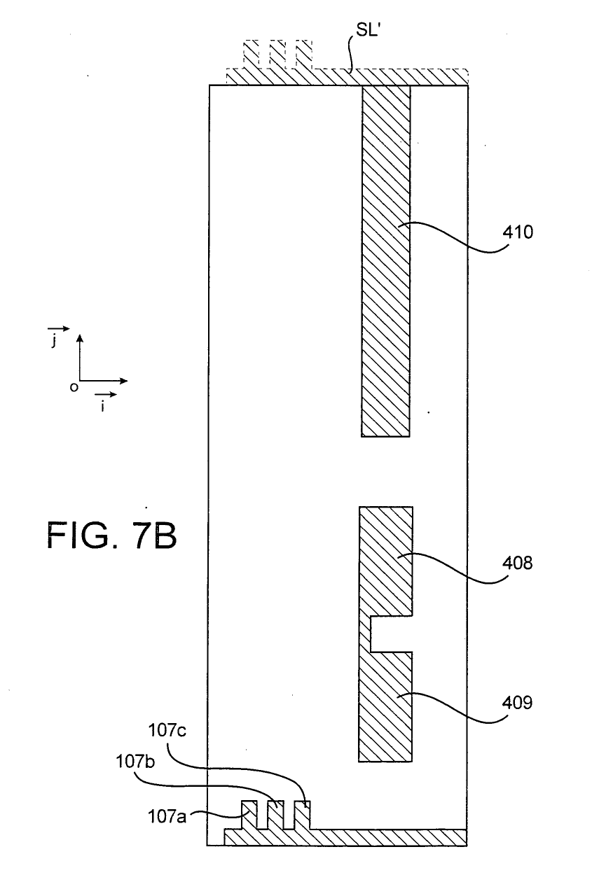

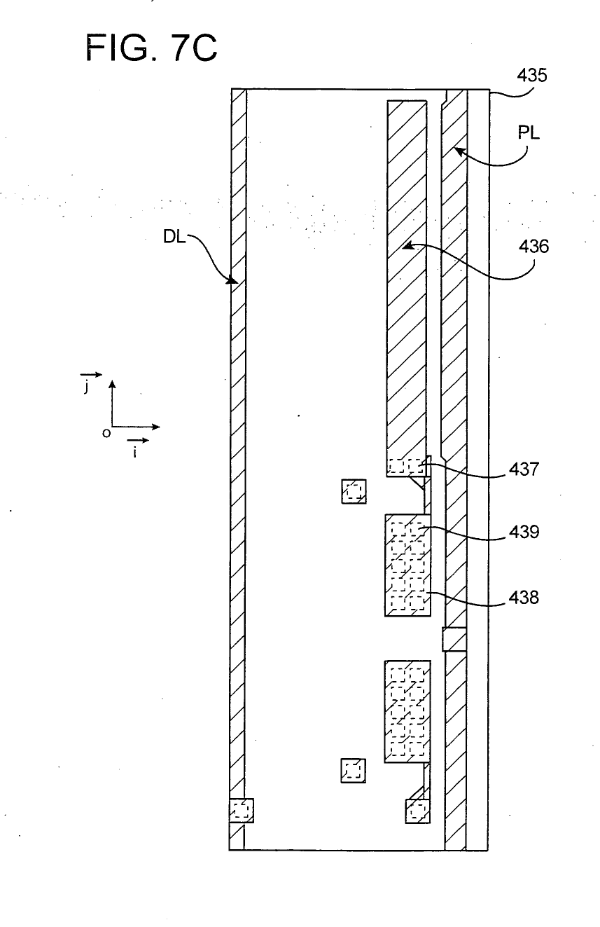

The technological stack of FIG. 6 notably comprises an active layer, the patterns of which are illustrated in FIG. 7A. The patterns of the active layer differ from those of the active layer comprised in the exemplary stack described earlier, notably at an area marked as 404, which forms the first electrode for the capacitor C′s1, and which has in this example a shape of a rectangle the length of which is parallel to the \vec{j} axis of a reference system [O; \vec{i}; \vec{j}]. An area marked as 402 of the active layer, forms the active area of the modulating transistors TFT2a and TFT2b and is located between the first electrode of the capacitor C′s1 and another area marked as 400 of the active layer playing the role of an active area for the switching transistor TFT1.

The technological stack of FIG. 6 also comprises a layer based on gate material marked as 411, over the active layer, the patterns of which are illustrated in FIG. 7B. Among the patterns of the layer based on gate material marked as 411, an area marked as 410 with the shape of a rectangle, the length of which is parallel to the \vec{j} axis of a reference system [O; \vec{i}; \vec{j}], forms a second electrode for the capacitor C′s1. This second electrode as for the pixel example described earlier, is connected to a selection line SL′ of another pixel P′ neighbouring pixel P and located on a same vertical row of the matrix as the latter. The area marked as 410 further forms an electrode for the capacitor C′s2. An area of the gate material layer, including portions marked as 408 and 409, capable of forming the gate of the first modulating transistor TFT2a and the gate of the second modulating transistor TFT2b, is located between the area 410 and the juxtaposed areas marked as 107a, 107b, 107c, forming a multi-gate structure for the switching transistor TFT1.

The technological stack further comprises a metal layer noted as 435, located over the layer based on gate material 411, and the patterns of which are illustrated in FIG. 7C. The bias line PL as well as the data line DL, are notably formed in the metal layer 435. Relatively to the metal layer 235 of the exemplary stack described earlier, the metal layer 435 notably comprises an additional pattern marked as 436, with the shape of rectangle, the length of which is parallel to the \vec{j} axis of an orthogonal reference system [O; \vec{i}; \vec{j}]. The pattern 436 forms another electrode for the capacitor C′s2. This second electrode is connected to the first electrode of the capacitor C′s1 formed in the active layer 405, through vias or vertical contacts marked as 437. The pattern 436 is further connected to another additional pattern 438 formed in the metal layer 435 and which, through vias or vertical contacts 439 is connected to the gate of the first current-modulating transistor TFT2b.

This is an alternative here with which contacts (stored contacts) may be made in order to provide a gain in emission surface. This type of contact might very well have been used in FIG. 5C.

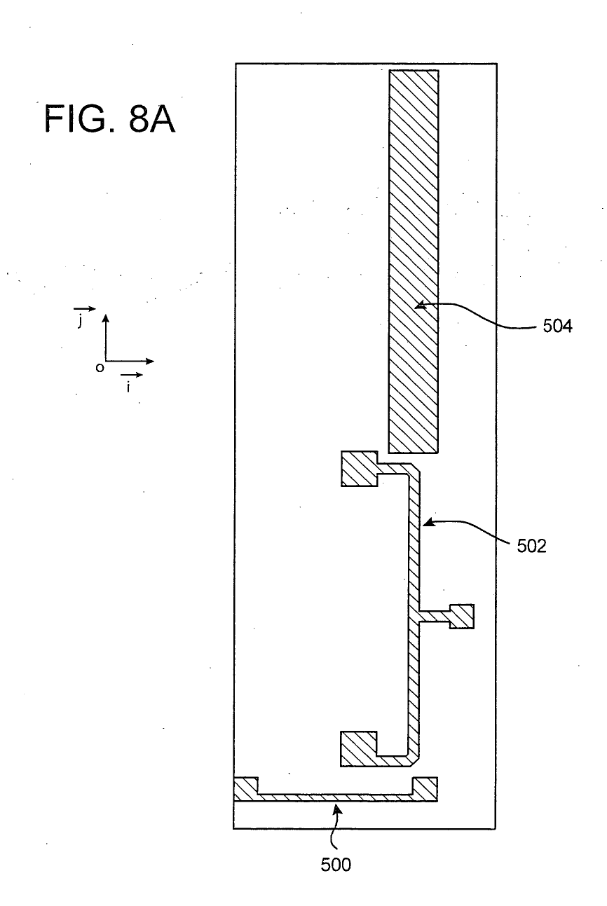

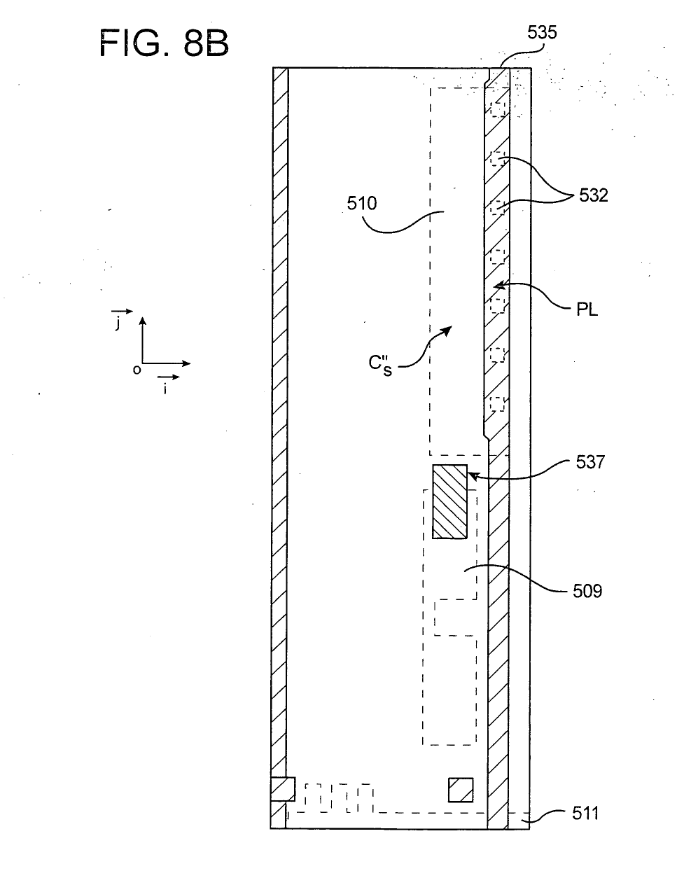

FIGS. 8A and 8B illustrate an alternative technological stack, in a top view of a pixel, of the type of those comprised in the matrix described earlier in connection with FIG. 3.

In FIG. 8A, areas 500, 502, 504 formed from an active layer are illustrated. The area 502 is used as an active area for the current-modulating transistors and is located between an area 500 playing the role of active area for the switching transistor and an area 504 used as a first electrode of the storage capacitor.

In FIG. 8B, a layer based on gate material 511 located on the active-layer and another metal layer 535 located over the layer 511 are illustrated. In the layer based on gate material, an area 510 is notably formed for example with the shape of a rectangle, parallel in the direction of its length with the bias line PL of the pixel P. The bias line PL of the pixel P, as for it, is formed in the metal layer 535.

The area 510 of the gate material layer forms a second electrode of the storage capacitor C″s. The layout of the bias line PL relatively to the area 510 is such that an orthogonal projection on a same plane of the area 510 and of the line Pl, are at least partly coincident. The area 510 is electrically connected to the bias line PL via vertical contacts 532. Thus, the bias line PL is used as a fixed potential line for one of the electrodes of the capacitor C″s. The other electrode of the capacitor C″s (not shown in this figure) is linked or connected to the gate of the current-modulating transistor TFT2a via an interconnection 537 formed in the metal layer 535.

According to this alternative, in the technological stack, the current-modulating transistors TFT2a and TFT2b may be located between the switching transistor and the storage capacitor Cs. The current-modulating transistors TFT2a and TFT2b, and the storage capacitor Cs may be located between the bias line PL and the light-emitting diode.

1-11. (canceled)

12. A microelectronic device with which light radiation may be produced, provided with a matrix including a plurality of pixels, each pixel being formed by a stack of layers, the device comprising:
electroluminescent means for emitting light radiation depending on an input current;
current-modulating means for modulating the input current of the electroluminescent means according to a control signal forwarded by a line of data;
switching means connected to the line of data, for transmitting the control signal or not, to the current-modulating means depending on a selection signal;
a selection line connected to the switching means to forward the selection signal to the switching means;
a bias line connected to the current-modulating means, to forward a signal for biasing the current-modulating means; and
a capacitor, configured to retain the control signal at the input of current-modulating means and comprising a first electrode, connected to the current-modulating means, and a second electrode connected to a line for selecting another pixel, the current-modulating means being located between the storage capacitor and the switching means in the stack.

13. The microelectronic device according to claim 12, the storage capacitor being in contact with the line for selecting the another pixel over a distance of at least 50 μm or half of the width of the pixel.

14. The microelectronic device according to claim 12, the storage capacitor comprising a first portion located between the bias line and the electroluminescent means and a second portion located between the electroluminescent means and the line for selecting the another pixel.

15. The microelectronic device according to claim 12, the current-modulating means comprising at least one thin film transistor.

16. The microelectronic device according to claim 15, the current-modulating means comprising a first thin film transistor and a second thin film transistor sharing a common drain region and a common source region.

17. The microelectronic device according to claim 12, the storage capacitor having an L-shape.

18. The microelectronic device according to claim 12, the storage capacitor including two capacitors placed in parallel.

19. The microelectronic device according to claim 18, wherein the matrix includes a stack of thin layers comprising at least one active layer, at least one layer based on a gate material of transistors, and at least one metal layer, the storage capacitor including a first capacitor with an electrode formed in the active layer, and with an electrode formed in the gate material layer,
a second capacitor including an electrode formed in the metal layer and with an electrode common with the other electrode of the first capacitor.

20. The microelectronic device according to claim 12, the switching means comprising at least one thin film transistor.

21. The microelectronic device according to claim 12, wherein the electroluminescent means comprises an electrode formed with at least one layer of organic nature, the matrix being an OLED pixel matrix.

22. A microelectronic device with which light radiation may be produced, provided with a matrix including a plurality of pixels, each pixel being formed with a stack of layers, and device comprising:
electroluminescent means for emitting light radiation depending on an input current;
current-modulating means;
switching means connected to a line of data, for transmitting a control signal or not, to the current-modulating means depending on a selection signal;
a selection line connected to the switching means to forward the selection signal to the switching means;
a bias line connected to the current-modulating means, to forward a bias signal to the current-modulating means;
a capacitor, configured to retain the control signal at the input of the current modulating means and comprising a first electrode connected to the current-modulating means and a second electrode of the capacitor connected to the bias line, the modulating means being located in the stack, between the storage capacitor and the switching means.

23. The microelectronic device according to claim 22, the current-modulating means comprising a first thin film transistor and a second thin film transistor sharing a common drain region and a common source region.

24. The microelectronic device according to claim 22, the storage capacitor having an L-shape.

25. The microelectronic device according to claim 22, the storage capacitor including two capacitors placed in parallel.

26. The microelectronic device according to claim 25, wherein said matrix includes a stack of thin layers comprising at least one active layer, at least one layer based on a gate material of transistors, and at least one metal layer, the storage capacitor including a first capacitor with an electrode formed in the active layer, and with an electrode formed in the gate material layer,
a second capacitor including an electrode formed in the metal layer and with an electrode common with the other electrode of the first capacitor.

27. The microelectronic device according to claim 22, the switching means comprising at least one thin film transistor.

28. The microelectronic device according to claim 22, wherein the electroluminescent means comprises an electrode formed with at least one layer of organic nature, the matrix being an OLED pixel matrix.
